(19) United States
(12) Patent Application Publication
(10) Pub. No.: US 2025/0322645 A1
(43) Pub. Date: Oct. 16, 2025

(54) TARGET RECOGNITION METHOD, MULTI-TASK NETWORK MODEL TRAINING METHOD, AND ELECTRONIC DEVICE

(71) Applicant: Shenzhen Reolink Technology Co., Ltd., Shenzhen (CN)

(72) Inventors: Zhenguo Chen, Shenzhen (CN); Qingjie Chen, Shenzhen (CN); Yanchong Chai, Shenzhen (CN); Hao Gan, Shenzhen (CN)

(21) Appl. No.: 19/247,201

(22) Filed: Jun. 24, 2025

(30) Foreign Application Priority Data
Jun. 26, 2024 (CN) 202410848576.7

(51) Int. Cl. G06V 10/764; G06T 7/00; G06T 7/11; G06V 10/40

(52) U.S. Cl. CPC G06V 10/764; G06T 7/0002; G06T 7/11; G06V 10/40; G06T 2207/20132; G06T 2207/30168; G06V 2201/07

(57) ABSTRACT

This application provides target recognition method, a multi-task network model training method, and an electronic device. The target recognition method includes: inputting video images into a multi-task network model one by one to obtain a predicted feature map; performing post-processing on the predicted feature map to obtain a target detection result; judging whether a target class confidence degree is greater than a preset confidence degree; if so, judging whether a target image quality score is greater than a preset score; if so, cropping out a target image from the video images according to a target detection box; and inputting the target image into a target recognition model corresponding to the target class to obtain a target name. In this way, this application decreases the number of calls of the recognition model, and also reduces a training duration of the model.

### TECHNICAL FIELD

This application relates to the technical field of image processing, and more particularly relate to a target recognition method, a multi-task network model training method, and an electronic device.

### BACKGROUND

Intelligent video monitoring is an important aspect in the field of computer vision, and the main work thereof is to extract interested targets from video images of dynamic scenes by utilizing the technologies such as target detection and target recognition.

At present, in-depth learning has become the main technical route of target image quality evaluation, target detection and target recognition tasks. In video monitoring scenes, high-quality images not only help to recognize the targets more accurately, but also can significantly reduce the misrecognition rate, thereby improving the reliability and efficiency of a monitoring system. Therefore, the combination of target image quality evaluation with target detection and target recognition tasks has become an important trend of the current video monitoring technology development.

In the process of combining target image quality evaluation with target detection and target recognition tasks, the first technical solution based on in-depth learning is to design all the target detection, target image quality evaluation and target recognition as independent-task algorithms, and the second technical solution is to design target detection as an independent-task algorithm and target image quality evaluation and target recognition as single-model multi-task algorithms, wherein a model of the first solution has high accuracy, which may significantly reduce the misrecognition rate, but due to the need of one independent image quality evaluation model, a training duration of the model, a camera side memory and a bandwidth load are increased, which is not applicable to the scene with limited camera side resources and high real-time requirements. In the second solution, target image quality evaluation is integrated into a target recognition algorithm to become one independent function branch of a target recognition model, which reduces the memory occupation of the camera side of the model, and is friendlier to the scene with limited camera side resources, but the number of calls of the target recognition model of a cloud server cannot be decreased, and the cost of transmitting target images to the cloud server by the camera side cannot be saved for the target detection of the camera side and the target recognition mode of the cloud server.

### SUMMARY

This application provides a target recognition method, a multi-task network model training method, and an electronic device, which decrease the number of calls of a recognition model, reduce the transmission cost of target image data in a mode of target detection at a camera side and target recognition at a cloud server, and also solve the problems of relatively long training duration of the model, occupation of a camera side memory, and a heavy bandwidth load existing in the prior art simultaneously.

According to one aspect of the present application, a target recognition method is provided, including: inputting video images into a multi-task network model one by one to obtain a predicted feature map; performing post-processing on the predicted feature map to obtain a target detection result, the target detection result containing a target detection box, a target class confidence degree, and a target image quality score; judging whether the target class confidence degree is greater than a preset confidence degree; if the target class confidence degree is greater than the preset confidence degree, judging whether the target image quality score is greater than a preset score; if the target image quality score is greater than the preset score, cropping out a target image from the video images according to the target detection box; and inputting the target image into a target recognition model to recognize a target name of the target image.

In an optional mode, performing post-processing on the predicted feature map to obtain a target detection result, includes: performing non-maximum suppression processing on the predicted feature map to screen out the target detection result from a plurality of candidate boxes; and performing decoding processing on a target detection box of the target detection result to obtain the target detection box.

In an optional mode, the multi-task network model includes a feature extraction module, a multi-scale feature fusion module, and a detection head module, the detection head module includes a plurality of scale branches, each scale branch includes a detection regression branch, a class prediction branch, and a quality evaluation branch, a last convolution layer of the quality evaluation branch is connected in parallel with a last convolution layer of the detection regression branch, the quality evaluation branch and the detection regression branch share remaining convolution layers, the predicted feature map contains the target detection box, the target class confidence degree and the target image quality score of the plurality of candidate boxes, the target detection box is output by the detection regression branch, the target class confidence degree is output by the class prediction branch, and the target image quality score is output by the quality evaluation branch.

In an optional mode, inputting the video images into a multi-task network model one by one to obtain a predicted feature map, includes: inputting the video images into a feature extraction module one by one, and performing feature extraction on the video images through the feature extraction module to obtain feature maps of the video images at different scales; inputting the feature maps at different scales into the multi-scale feature fusion module, and performing feature fusion on the feature maps at different scales through the multi-scale feature fusion module to obtain fused feature maps of the video images at different scales; inputting the fused feature maps at different scales into the detection head module; performing target detection prediction on the fused feature maps through the detection regression branch to obtain the target detection box of the plurality of candidate boxes; performing target class prediction on the fused feature maps through the class prediction branch to obtain the target class confidence degrees of the plurality of candidate boxes; and performing quality evaluation prediction on the fused feature maps through the quality evaluation branch to obtain the target image quality score of the plurality of candidate boxes.

According to another aspect of the present application, a multi-task network model training method for target recognition is provided, including: constructing a multi-task network model; constructing a loss function calculation module; randomly extracting a plurality of training images in a training image set to constitute a batch of images, wherein the training image set includes a plurality of training images marked with labels, and the label includes a target label box, a class label, and a quality label score; inputting the training images in the batch of images into the multi-task network model one by one to obtain a predicted feature map, wherein the predicted feature map contains a target detection box, a target class confidence degree and a target image quality score of a plurality of candidate boxes; inputting the target detection box, the target class confidence degree and the target image quality score of the plurality of candidate boxes, and the target label box, the class label, and the quality label score of the training image in the batch of images into the loss function calculation module to obtain a model loss of the multi-task network model; calculating a gradient of the model loss to each parameter of the multi-task network model by using a back-propagation algorithm, and updating the parameters of the multi-task network model according to the gradient; judging whether the multi-task network model converges; if the multi-task network model converges, saving the parameters of the multi-task network model; and if the multi-task network model does not converge, executing the step of randomly extracting a plurality of training images in a training image set to constitute a batch of images.

In an optional mode, a total number of images of the batch of images is N, wherein N≥1; the model loss Lₛᵤₘ of the multi-task network model is as follows: Lₛᵤₘ=λ_{cls}L_{cls}+λ_{box}L_{box}+λ_{dfl}L_{dfl}+λ_{iqa}L_{iqa}, where L_{cls} represents a class loss of the multi-task network model, L_{box} represents a bounding box regression loss of the multi-task network model, L_{dfl} represents a class distribution loss of the multi-task network model, L_{iqa} represents an image quality evaluation loss of the multi-task network model, and λ_{cls}, λ_{box}, λ_{dfl} and λ_{iqa} represent parameters of L_{cls}, L_{box}, L_{dfl} and L_{iqa} respectively; the image quality evaluation loss L_{iqa} of the multi-task network model is as follows:

$${L}_{iqa} = \frac{1}{N} {\sum }_{i = 1}^{N} ( \vert {IQA}_{g t} - {IQA}_{pred} \vert \times IoU \times flag ) ,$$

where IQA_{gt} represents the quality label score of the training image, IQA_{pred} represents the target image quality score of the training image, IoU represents a ratio of an intersection set area and a union set area of the target label box and the target detection box of the training image, flag represents whether a flag bit of the quality label score exists in the training image, if the quality label score exists in the training image, flag is 1, and if the quality label score does not exist in the training image, flag is 0.

In an optional mode, the method further includes: constructing a data enhancement module, wherein the data enhancement module uses at least one of a plurality of data enhancement methods to perform data enhancement on an image, the plurality of data enhancement methods include a color transformation method, a scale transformation method, an up-down turnover transformation method, a left-right turnover transformation method, a rotation transformation method, and a target copy and paste transformation method; and inputting the training images in the batch of images into the multi-task network model one by one to obtain a predicted feature map, includes: inputting the training images in the batch of images into the data enhancement module one by one to obtain a data enhancement image; and inputting the data enhancement image into the multi-task network model to obtain the predicted feature map.

In an optional mode, the method further includes: verifying the multi-task network model, a verification method for the multi-task network model including the following steps: loading a parameter of the multi-task network model saved in a current training round; inputting a verification image in a verification image set into the multi-task network model to obtain a target detection box, a target class confidence degree, and a target image quality score of the verification image, wherein the verification image set includes a plurality of verification images marked with labels, and the label includes a target label box, a class label, and a quality label score; calculating a model index of the multi-task network model in the current training round according to the target detection box, the target class confidence degree, and the target image quality score of the verification image, and the target label box, the class label, and the quality label score of the training image; judging whether the model index in the current training round is greater than a preset index; if the model index in the current training round is greater than the preset index, taking the parameter of the multi-task network model in the current training round as an optimal network parameter, updating the preset index by using the model index in the current training round, and executing the step of randomly extracting a plurality of training images in a training image set to constitute a batch of images until a maximum training round is reached; and if the model index in the current training round is less than or equal to the preset index, executing the step of randomly extracting a plurality of training images in a training image set to constitute a batch of images until the maximum training round is reached.

In an optional mode, the method further includes: testing the multi-task network model, a test method for the multi-task network model including the following steps: loading a saved parameter of the multi-task network model; inputting a test image into the multi-task network model to obtain a target detection result of the test image, wherein the target detection result includes a target detection box, a target class confidence degree, and a target image quality score; judging whether the target class confidence degree of the target detection result is greater than a preset confidence degree; if the target class confidence degree of the target detection result is greater than the preset confidence degree, outputting the target detection box, a target class corresponding to a highest target class confidence degree, and the target image quality score; and if the target class confidence degree of the target detection result is less than or equal to the preset confidence degree, executing the step of inputting a test image into the multi-task network model to obtain a target detection result of the test image.

In an optional mode, the method further includes: generating one image quality label interface and displaying the image quality label interface on a display screen of an electronic device; displaying the training image and a target rectangular box on the image quality label interface; when the target rectangular box is selected, performing mask processing on all backgrounds outside a selected target foreground of the training image, an image in the target rectangular box being a target image; and performing quality scoring on the target image to obtain the quality label score.

In an optional mode, the multi-task network model includes a feature extraction module, a multi-scale feature fusion module, and a detection head module, the detection head module includes a plurality of scale branches, each scale branch includes a detection regression branch, a class prediction branch, and a quality evaluation branch, a last convolution layer of the quality evaluation branch is connected in parallel with a last convolution layer of the detection regression branch, and the quality evaluation branch and the detection regression branch share remaining convolution layers.

In an optional mode, the detection regression branch outputs the target detection box, the class prediction branch outputs the target class confidence degree, and the quality evaluation branch outputs the target image quality score.

In the present application, by inputting the video images extracted frame by frame into the multi-task network model to perform target detection, target class prediction and image quality evaluation, the predicted feature map including the target detection box, the target class confidence degree and the target image quality score of a plurality of candidate boxes is obtained; the target detection result is obtained by performing post-processing on the predicted feature map, and when the target class confidence degree of the target detection result is greater than the preset confidence degree and the target image quality score of the target detection result is greater than the preset score, the target image which is obtained by cropping the video images according to the target detection box of the target detection result and only contains the target foreground is input into the target recognition model to perform target recognition to obtain the target name; by using the multi-task network model to predict and obtain the image which only contains the target foreground and predict the quality of the image, the quality of the target image input into the target recognition model may be controlled, which not only effectively reduces the target misrecognition rate, but also decreases the number of calls of the target recognition model and reduces the operation load of a camera device. In addition, in the mode of target detection at the camera side and target recognition at the cloud server, the transmission cost of target image data may be reduced, the storage of useless information may be avoided, and the bandwidth load and the memory occupancy rate may be reduced.

According to another aspect of the present application, an electronic device is provided, including a memory, a processor, and a computer program stored on the memory, wherein the processor executes the computer program to implement the steps of the target recognition method or the multi-task network model training method provided in any example described above.

The above description is merely an overview of the technical solutions of the examples of the present application. In order that the technical means of the examples of the present application can be more clearly understood, the examples of the present application may be implemented in accordance with the contents of the specification, and in order that the above and other objects, features and advantages of the examples of the present application can be more apparent and readily understood, specific embodiments of the present application are set forth hereinafter.

### BRIEF DESCRIPTION OF THE DRAWINGS

The accompanying drawings are only for purposes of illustrating the embodiments and are not to be construed as limiting the present application. Also, like reference numerals represent like parts throughout the drawings. In the drawings:

FIG. 1 shows a schematic diagram of an application scene provided in an example of the present application;

FIG. 2 shows a schematic flow diagram of a multi-task network model training method provided in an example of the present application;

FIG. 3 shows a schematic structural diagram of a multi-task network model provided in an example of the present application;

FIG. 4 shows a schematic structural diagram of a detection head module provided in an example of the present application;

FIG. 5 shows a flowchart of a verification method for the multi-task network model provided in an example of the present application;

FIG. 6 shows a flowchart of a test method for the multi-task network model provided in an example of the present application;

FIG. 7 shows a flowchart of a target recognition method provided in an example of the present application; and

FIG. 8 shows a schematic structural diagram of an electronic device provided in an example of the present application.

### DETAILED DESCRIPTION OF THE INVENTION

Hereinafter, illustrative examples of the present application will be described in more detail with reference to the accompanying drawings. Although the illustrative examples of the present application are shown in the accompanying drawings, it is to be understood that the present application may be implemented in various forms and should not be limited to the examples set forth herein.

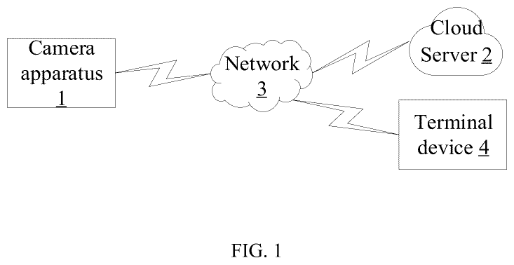

FIG. 1 shows a schematic diagram of an application scene provided in an example of the present application, and as shown in the figure, a camera apparatus 1 establishes a communication connection with a cloud server 2 via a network 3, and a terminal device 4 establishes a communication connection with the cloud server 2 via the network 3. The camera apparatus 1 may be a camera for security monitoring, an animal monitoring camera, an IP camera or other video monitoring devices. The network 3 includes but is not limited to one or more of an LAN, an MAN, a WAN, a 4G/5G network, WIFI, Bluetooth, and a peer-to-peer (P2P) communication network. The terminal device 4 may be a touch control type mobile phone, a smart phone, a tablet computer, a computer, a portable terminal device or other terminal electronic apparatuses with display screens.

In the example of the present application, the camera apparatus 1 and the terminal device 4 may each include one or more processors, and the processor may be a central processing unit (CPU), or an application specific integrated circuit (ASIC), or one or more integrated circuits configured to implement this example, which is not limited herein. One or more processors included in the terminal device may be processors of the same type, such as one or more CPUs, and may also be processors of different types, such as one or more CPUs and one or more ASICs, which is not limited herein.

The camera apparatus 1 is installed in an area to be monitored (such as a house, an office, a mall, a field and a road), so that the camera apparatus 1 can shoot a monitoring video in the monitored area. After shooting the monitoring video, the camera apparatus 1 may extract video images by extracted frames or frame by frame, and may upload target images with target image quality evaluation satisfying an expected threshold value to the cloud server 2 via the network 3 after performing target detection and target image quality evaluation on the video images, and after target recognition is performed on the target images by the cloud server 2, the target images and a target name obtained by recognition are sent to the terminal device 4 via the network 3 for a user to browse.

For example, when the camera apparatus 1 shoots a video of an animal A, the camera apparatus 1 can extract video images from the video, after target detection and target image quality evaluation are performed on the video images, target images including the animal A with the target image quality satisfying the expected threshold value are sent to the cloud server 2, and after the cloud server 2 recognizes the target images to obtain a target name of animal A, the target images and the target name are sent to the terminal device 4 via the network 3.

In some application scenes where the camera apparatus 1 has the functions of target detection, target image quality evaluation and target recognition, when the camera apparatus 1 shoots the video of the animal A, the camera apparatus 1 extracts the video images from the video, after target detection and target image quality evaluation are performed on the video images, the target images including the animal A with the target image quality satisfying the expected threshold value are directly recognized to obtain the target name of animal A, and then the target images and the target name are sent to the terminal device 4 via the network 3.

In some application scenes where the camera apparatus 1 does not have the target recognition function, when the camera apparatus 1 shoots the video of the animal A, the camera apparatus 1 extracts the video images from the video, after target detection and target image quality evaluation are performed on the video images, the camera apparatus 1 sends the target images including the animal A with the target image quality satisfying the expected threshold value to the cloud server 2 via the network 3, the cloud server 2 recognizes the target images to obtain the target name of animal A, and then the target images and the target name are sent to the terminal device 4 by the cloud server 2 via the network 3 to be displayed to the user.

In the example of the present application, a trained multi-task network model is used to perform target detection, target class confidence degree detection, and target image quality evaluation on the video images to obtain the predicted feature map, then the target image quality is judged based on the predicted feature map, and the target image is cropped and subjected to class recognition when the quality of the target image satisfies the preset requirements. Firstly, a multi-task network model training method used in the example of the present application will be described.

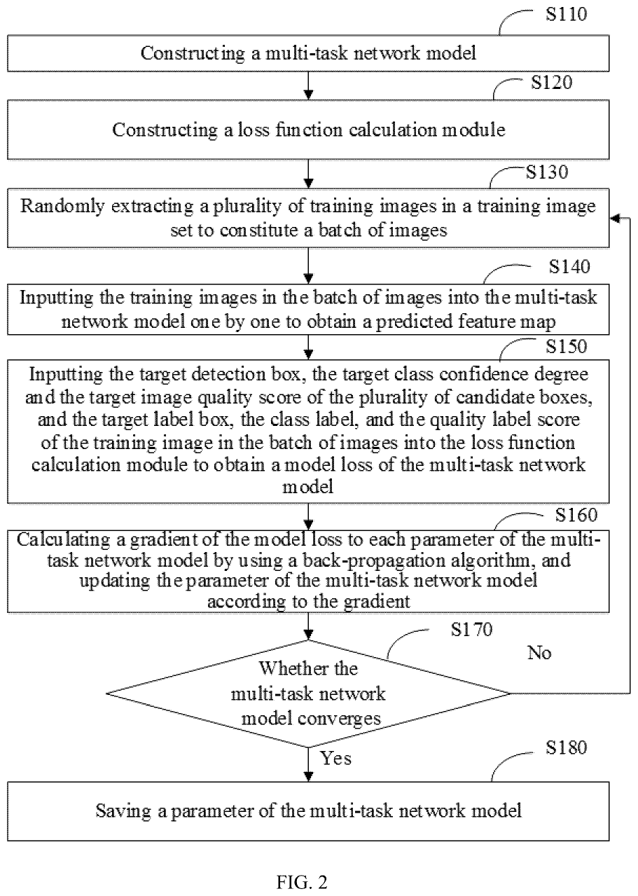

FIG. 2 shows a flowchart of a multi-task network model training method provided in an example of the present application. In the method, the construction and training of a multi-task network model may be completed by a local offline electronic device (such as an offline computer device), and the trained multi-task network model is installed in an AI chip of a camera apparatus 1. The multi-task network model is used to perform target detection and target image quality evaluation on an image containing any target (such as a human face, an animal and a vehicle), may perform target detection and target image quality evaluation on an image containing one target, and may also perform target detection and target image quality evaluation on an image containing a plurality of targets. For example, when target detection and target image quality evaluation are performed on images extracted from a video shot by the camera apparatus 1, the camera apparatus 1 may send the video images to a terminal device 4 via a network 3, and display a target image detected from the video images and a target name on the terminal device 4. As shown in FIG. 2, the multi-task network model training method includes the following steps.

Step S110: constructing a multi-task network model.

Before constructing the multi-task network model, datasets required by the multi-task network model needs to be firstly constructed, wherein the datasets may be divided into a training image set and a verification image set, including but not limited to animal images, human face images, automobile images, and the like, the training image set is used to learn model parameters, and the verification image set is used to adjust model configuration, evaluate model performance and prevent over-fitting. By reasonably dividing the datasets and using the datasets to train and evaluate the model, the capability of the model to generalize to new data in practical applications may be increased;
wherein the training image set includes a plurality of training images marked with labels, and the label includes a target label box, a class label, and a quality label score; and the verification image set includes a plurality of verification images marked with labels, and the label includes a target label box, a class label, and a quality label score. Specifically, the target label box is a rectangular box for representing a position and a size of the target in the image, the class label represents a class of the target in the target label box, the quality label score refers to an evaluation value of the quality of the image in the target label box, and scoring may be performed based on a specific image quality index or evaluation criterion, such as resolution, color depth, contrast, and noise level. The training images include, but are not limited to, person images, animal images, automobile images, and the like.

Taking the animal image as an example, the target label box represents the position and the size of an animal in the image, the class label of 0 represents that the target class in the target label box is the animal, and the quality label score represents the evaluation value of the image quality of the animal in the target label box. When a plurality of animals are included in the image, each animal has a corresponding target label box, class label, and quality label score.

In the example of the present application, the process of constructing the training image set and the verification image set is described by taking the animal image as an example.

A public dataset of animals is collected from the network, animal videos are collected from various camera apparatuses, and images are extracted by extracted frames or frame by frame to compose a private dataset. The public dataset and the private dataset are integrated, and image annotation software (such as LabelImg) is used to draw the target label box on the image, wherein the target label box may be a rectangular box, a polygonal box, and the like. An animal in each animal image is taken as a target, and when a plurality of animals are included on the image, the target label box is drawn one by one by taking each animal as the target. The class label is set for each target label box, for example, setting the class label to be 0 represents that the target class in the target label box is the animal, thereby constituting an animal detection dataset.

The animal detection dataset is randomly divided into a dataset A and a dataset B in the proportion of 1:1. Image quality scoring is performed on all images in the dataset A to obtain the quality label score, such as a quality label score within 0 to 10. The quality label scores of all images in the dataset B are set to be 0, which represents that the quality label scores are not marked. At this point, the construction of the animal detection dataset and the target image quality dataset are completed.

The dataset A and the dataset B are randomly divided into a training set and a validation set in the proportion of 9:1. The training set of the dataset A and the training set of the dataset B are integrated to obtain a training image set, and the verification set of the dataset A and the verification set of the dataset B are integrated to obtain a verification image set, which are respectively used to train and verify the model.

At this point, the construction of the training image set and the verification image set is completed.

In some examples, target image quality annotation software autonomously and secondarily developed based on the LabelImg software may be used to perform image quality scoring on all images of the dataset A respectively to obtain the quality label score of each image. Specifically, an image quality label interface is firstly generated and displayed on a display screen of an electronic device (such as an offline computer device, the offline electronic device being not shown in FIG. 1). The images of the dataset A and the target rectangular box are displayed on the image quality label interface, wherein the target rectangular box may be the target label box drawn above or a redrawn rectangular box. The target rectangular box clicked, that is, when the target rectangular box is selected, the software performs mask processing on all backgrounds outside the target rectangular box (that is, a target foreground) in the image, and an image in the target rectangular box obtained after background interference is excluded is the target image. Finally, the quality label score of the image may be obtained by performing quality scoring on the target image.

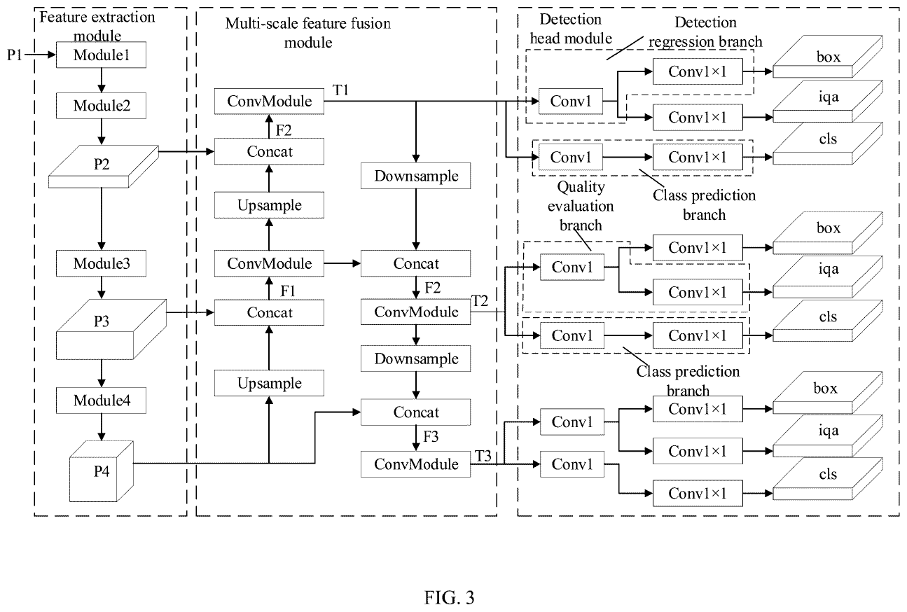

FIG. 3 shows a schematic structural diagram of a multi-task network model provided in an example of the present application, and as shown in the figure, the multi-task network model includes a feature extraction module, a multi-scale fusion module, and a detection head module, wherein the detection head module includes a plurality of scale branches, for example, may include three scale branches, namely, a large scale branch, a medium scale branch, and a small scale branch, can be included, each scale branch includes a detection regression branch, a class prediction branch, and a quality evaluation branch, a last convolution layer of the quality evaluation branch is connected in parallel with a last convolution layer of the detection regression branch, and the quality evaluation branch and the detection regression branch share remaining convolution layers;

The feature extraction module may perform feature extraction on the image to obtain the feature map with rich image information. A plurality of convolution modules may be provided in the feature extraction module, for example, four convolution modules are provided: Module 1, Module 2, Module 3, and Module 4, and feature extraction is performed on the images input into the feature extraction module sequentially to obtain a plurality of feature maps at different scales, for example, feature maps at three scales, namely, a large scale, a medium scale, and a small scale are obtained.

The multi-scale fusion module is used to perform feature fusion on a plurality of feature maps at different scales output by the feature extraction module. In the example of the present application, after feature fusion is performed on the feature maps by the multi-scale fusion module, three fused feature maps with deep semantic information and shallow positioning information at the large scale, the medium scale, and the small scale may be obtained.

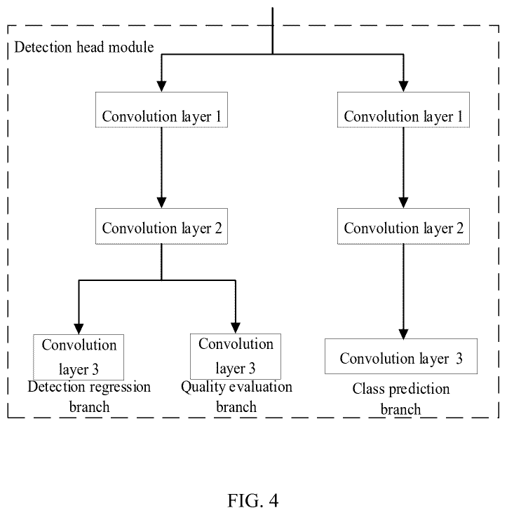

FIG. 4 shows a schematic structural diagram of a detection head module provided in an example of the present application, and as shown in FIG. 4, a detection regression branch, a class prediction branch and a quality evaluation branch of each scale branch of the detection head module respectively perform target detection prediction, class prediction and quality evaluation prediction on each candidate box. As shown in FIG. 3, different scale branches of the detection head module respectively perform target detection prediction, class prediction and quality evaluation prediction on a plurality of candidate boxes of the fused feature maps at different scales, for example: the detection regression branch, the class prediction branch and the quality evaluation branch of the large-scale branch in the detection head module performs target detection prediction, class prediction and quality evaluation prediction on the fused feature map at the large scale.

Since the target image input into the target recognition model is a local image containing only the target foreground, it is only necessary to perform quality evaluation on the local image of each target in the image, and this is strongly related to the detection regression branch of the detection head module. The last convolution layer of the quality evaluation branch is connected in parallel with the last convolution layer of the detection regression branch, and the quality evaluation branch and the detection regression branch share the remaining convolution layers, so that the purpose of predicting the quality of the local image of each target may be achieved.

As shown in FIG. 4, the detection regression branch, the class prediction branch, and the quality evaluation branch may each include three convolution layers: a convolution layer 1, a convolution layer 2 and a convolution layer 3, wherein the convolution layer 1 and the convolution layer 2 of the detection regression branch and the quality evaluation branch share parameters. For example, the number of convolution kernels in the convolution layer 1, the convolution layer 2 and the convolution layer 3 of the detection regression branch may be respectively set to be 64, 64 and 64, the depth of the convolution kernels may be respectively set to be 512, 64 and 64, the sizes of the convolution kernels are respectively set to be 3×3, 3×3 and 1×1, and offsets are respectively set to be 64, 64 and 64; the number of convolution kernels in the convolution layer 1, the convolution layer 2 and the convolution layer 3 of the quality evaluation branch may be respectively set to be 64, 64 and 1, the depth of the convolution kernels may be respectively set to be 512, 64 and 64, the sizes of the convolution kernels are respectively set to be 3×3, 3×3 and 1×1, and offsets are respectively set to be 64, 64 and 1; and the number of convolution kernels in the convolution layer 1, the convolution layer 2 and the convolution layer 3 of the class prediction branch may be respectively set to be 128, 128 and 1, the depth of the convolution kernels may be respectively set to be 512, 128 and 1, the sizes of the convolution kernels are respectively set to be 3×3, 3×3 and 1×1, and offsets are respectively set to be 128, 128 and 1.

Step S120: constructing a loss function calculation module.

Specifically, assuming that a total number of images of the batch of images is N, wherein N≥1, a calculation formula for a class loss L_{cls} of the multi-task network model is as follows:

$${L}_{cls} = \frac{1}{N} {\sum }_{i} - [ {y}_{i} \cdot log ( {p}_{i} ) + ( 1 - {y}_{i} ) \cdot log ( 1 - {p}_{i} ) ] ; \qquad Formula 1$$

where yᵢ represents a class label of an ith target label box, and pᵢ represents a target class confidence degree of a target in an ith target detection box. When the class label of the ith target label box is an animal, yᵢ is 1; and when the class label of the ith target label box is not the animal, yᵢ is 0, at this time, pᵢ represents the class confidence degree of the target being the animal in the ith target detection box.

A calculation formula for a bounding box regression loss L_{box} of the multi-task network model is as follows:

$${L}_{box} = {L}_{CIoU} = 1 - IoU + \frac{{ρ}^{2} ( b , {b}^{gt} )}{{c}^{2}} + α v , \qquad Formula 2$$

$$v = \frac{4}{{π}^{2}} {( arctan \frac{{w}^{g t}}{{h}^{g t}} - arctan \frac{w}{h} )}^{2} , α = \frac{v}{( 1 - IoU ) + v} ;$$

where ρ (b, b^{gt}) represents a distance between central points of a target label box bet and a target label box b, c represents a diagonal length of a minimum rectangular box (union set) enclosing the target label box and the target detection box, IoU represents a ratio of an intersection set area of the target label box and the target detection box to a union set area of the target label box and the target detection box, and w^{gt}, h^{gt}, w and h represent the width and height of the target label box and the target detection box respectively.

A calculation formula for a class distribution loss L_{dfl} of the multi-task network model is as follows:

$${L}_{dfl} = DFL ( {S}_{i} , {S}_{i + 1} ) = - ( ( {y}_{i + 1} - y ) log ( {S}_{i} ) + ( y - {y}_{i} ) log ( {S}_{i + 1} ) ) \qquad Formula 3$$

$${S}_{i} = \frac{{y}_{i + 1} - y}{{y}_{i + 1} - {y}_{i}} , {S}_{i + 1} = \frac{y - {y}_{i}}{{y}_{i + 1} - {y}_{i}} ;$$

where y represents a target class confidence degree of the target label box, and yᵢ and yᵢ₊₁ represent two values closest to y respectively.

A calculation formula for an image quality evaluation loss L_{iqa} of the multi-task network model is as follows:

$${L}_{iqa} = \frac{1}{N} {\sum }_{i = 1}^{N} ( \vert {IQA}_{g t} - {IQA}_{p r e d} \vert \times IoU \times flag ) , \qquad Formula 4$$

where IQA_{gt} represents a quality label score of the image in the target label box of the training image, IQA_{pred} represents a target image quality score of the image in the target detection box of the training image, IoU represents a ratio of an intersection set area to a union set area of the target label box and the target detection box of the training image, flag represents whether a flag bit of the quality label score exists in the training image, if the quality label score exists in the training image, flag is 1, and if the quality label score does not exist in the training image, flag is 0.

A calculation formula for a model loss Lₛᵤₘ of the multi-task network model is as follows:

$${L}_{sum} = {λ}_{cls} {L}_{cls} + {λ}_{box} {L}_{box} + {λ}_{dfl} {L}_{dfl} + {λ}_{iqa} {L}_{iqa} , \qquad Formula 5$$

where L_{cls} represents a class loss of the multi-task network model, L_{box} represents a bounding box regression loss of the multi-task network model, L_{dfl} represents a class distribution loss of the multi-task network model, L_{iqa} represents an image quality evaluation loss of the multi-task network model, and λ_{cls}, λ_{box}, λ_{dfl} and λ_{iqa} represent parameters of L_{cls}, L_{box}, L_{dfl} and L_{iqa} respectively.

Step S130: randomly extracting a plurality of training images in a training image set to constitute a batch of images;
wherein the training image set includes a plurality of training images marked with labels, and the label includes a target label box, a class label, and a quality label score.

Specifically, a plurality of training images are randomly extracted from the above constructed training image set to constitute the batch of images, and preferably, the total number of images of the training images extracted each time is fixed to be N, N≥1.

Step S140: inputting the training images in the batch of images into the multi-task network model one by one to obtain a predicted feature map;
wherein the predicted feature map contains a target detection box, a target class confidence degree and a target image quality score of a plurality of candidate boxes, the detection regression branch outputs the target detection box, the class prediction branch outputs the target class confidence degree, and the quality evaluation branch outputs the target image quality score.

Step S140 specifically includes:
step a1: inputting the video images into a feature extraction module one by one, and performing feature extraction on the video images through the feature extraction module to obtain feature maps of the video images at different scales;
step a2: inputting the feature maps at different scales into the multi-scale feature fusion module, and performing feature fusion on the feature maps at different scales through the multi-scale feature fusion module to obtain fused feature maps of the video images at different scales; and
step a3: inputting the fused feature maps at different scales into the detection head module, and performing target detection prediction on the fused feature maps through the detection regression branch to obtain the target detection box of the plurality of candidate boxes; performing target class prediction on the fused feature maps through the class prediction branch to obtain the target class confidence degrees of the plurality of candidate boxes; and performing quality evaluation prediction on the fused feature maps through the quality evaluation branch to obtain the target image quality score of the plurality of candidate boxes.

In the process of training the model, N training images in the batch of images are sequentially input into the multi-task network model to train the model.

In the example of the present application, one training image is input, and the multi-task network model outputs the predicted feature maps of the training image at different scales, for example, three scale branches, namely, a large-scale branch, a medium-scale branch and a small-scale branch, in the detection head module correspondingly output the predicted feature maps of the training image at three scales, namely, a large scale, a medium scale and a small scale respectively, wherein each predicted feature map includes a plurality of candidate boxes and a predicted detection result of each candidate box, wherein the detection result includes a target detection box, a target class confidence degree, and a target image quality score. Specifically, the target detection box refers to a position and a size of the target in the training image which are predicted by the detection regression branch and expressed as integrals, the target class confidence degree refers to the possibility that the target in the target detection box is a certain class (such as an animal) which is predicted by the class prediction branch, and the target image quality score refers to an evaluation value of the quality of the image in the target detection box which is predicted by the quality evaluation branch.

A method of parameter sharing between the detection regression branch and the quality evaluation branch is adopted to perform target image quality evaluation on the image in each target detection box obtained by prediction of the detection regression branch, which can enable the model to focus on the image quality of the target foreground in the input image in the case where the image containing the foreground and the background is input into the model, thereby effectively preventing the negative impact of the background quality on the image quality prediction of the target foreground, and achieving the function of target image quality evaluation without increasing the memory occupancy rate of the camera apparatus 1 on the premise of avoiding increasing the size of the target detection model and affecting the performance of the target detection model. In addition, the problem that the target image quality evaluation model cannot be independently added due to the resource limitation of the camera apparatus 1 is effectively solved.

As previously described, the feature extraction module may perform feature extraction on training images to obtain feature maps at different scales, the multi-scale fusion module performs feature fusion on the feature maps at different scales to obtain fused feature maps at different scales, and finally, the detection regression branch, the class prediction branch and the quality evaluation branch of a plurality of scale branches of the detection head module perform target detection prediction, target class prediction and quality evaluation prediction on the fused feature maps at different scales respectively This process will be described in detail below.

As shown in FIG. 3, after a training image P1 is input into a feature extraction module, feature extraction is performed by modules which are a Module 1 and a Module 2 to obtain a feature map P2, the feature map P2 is subjected to feature extraction by a module which is a Module 3 to obtain a feature map P3, and the feature map P3 is subjected to feature extraction by a module which is a Module 4 to obtain a feature map P4.

The feature maps P2 to P4 are input into a multi-scale fusion module; after being subjected to one up-sampling and one convolution layer, the feature map P4 is subjected to feature fusion with the feature map P3 to obtain a fused feature map F1, after being subjected to one convolution layer and one up-sampling, the fused feature map F1 is subjected to feature fusion with the feature map P2 to obtain a fused feature map F2, and a fused feature map T1 is obtained after the fused feature map F2 is subjected to one convolution layer; after the fused feature map T1 is subjected to one down-sampling and the fused feature map F1 is subjected to one convolution layer, the two are subjected to feature fusion to obtain a fused feature map F2, and a fused feature map T2 is obtained after the fused feature map F2 is subjected to one convolution layer; after being subjected to one down-sampling, the fused feature map T2 is subjected to feature fusion with the feature map P4 to obtain a fused feature map F3, and a fused feature map T3 is obtained after the fused feature map F3 is subjected to one convolution layer; and finally, the fusion feature maps input into the detection head module by the multi-scale fusion module are as follows: the fused feature map T1, the fused feature map T2, and the fused feature map T3.

The detection regression branch of each scale branch respectively performs target detection prediction on the fused feature map T1, the fused feature map T2, and the fused feature map T3 to obtain the target detection box predicted by a plurality of candidate boxes; the last convolution layer of the quality evaluation branch of each scale branch respectively performs quality evaluation prediction on images in a plurality of target detection boxes in the fused feature map T1, the fused feature map T2, and the fused feature map T3 to obtain the target image quality score iqa predicted by the plurality of candidate boxes; and the class prediction branch of each scale branch respectively performs target class prediction on targets in a plurality of target detection boxes in the fused feature map T1, the fused feature map T2, and the fused feature map T3 to obtain the target class confidence degrees cls predicted by the plurality of candidate boxes.

After step a3, concat and reshape operations may be performed on the target detection box, the target class confidence degree and the target image quality score which are predicted by the plurality of candidate boxes. Specifically, prediction results of the predicted feature maps at different scales are connected through the concat operation, the model can process the prediction results at all scales in one framework to facilitate subsequent non-maximum suppression (NMS) processing, and through the reshape operation, it may be ensured that shapes of the prediction results match the input requirements of the subsequent processing steps, thereby avoiding unnecessary data conversion and data errors.

Taking a batch of images M×3×352×640 input into the multi-task network model as an example, the target detection box, the target class confidence degree, and the target image quality score output by the multi-task network model are M×66×4620, wherein M represents the number of images in a batch, 4620 represents the total number of all target detection boxes divided according to the large, medium and small scales of each training image, and 66 is composed of the target detection box (64) predicted by each candidate box+the target image quality score (1)+the target class confidence degree (1).

The features of the training image at different scales may be captured by the feature extraction module, which is helpful for the model to better understand and process complex input data. The feature maps at different scales are fused by the multi-scale fusion module, and feature information at different scales may be fully utilized to improve the performance of the model. Moreover, the model may detect the targets of different sizes by performing target detection prediction on the fused feature maps at different scales, so as to accurately predict the target detection box and improve the detection accuracy of the model.

The image containing only the target foreground is obtained by prediction of the detection regression branch, the class of the image target is predicted by the class prediction branch, and the quality of the image is predicted by the quality evaluation branch, so that the multi-task network model can predict the quality of the image including only the target foreground when the input images are images including the foreground and the background, thereby effectively preventing the negative impact of the background quality on the image quality prediction of the target foreground, achieving the function of target image quality evaluation on the premise of not affecting the performance of the original target detection model and not obviously increasing the memory occupancy rate of the camera apparatus 1, and effectively solving the problem that the target image quality evaluation model cannot be independently added due to the resource limitation at the camera side.

In some examples, the multi-task network model training method may further include constructing a data enhancement module, so that the number, diversity and quality of training images may be increased by the data enhancement module, and the performance and robustness of the model may be improved. Step S140 specifically includes the following steps:
step b1: inputting the training images in the batch of images into the data enhancement module one by one to obtain a data enhancement image; and
step b2: inputting the data enhancement image into the multi-task network model to obtain the predicted feature map;
wherein the data enhancement module uses a plurality of data enhancement methods to perform data enhancement processing on the training images, such as the data enhancement methods including a color transformation method, a scale transformation method, an up-down turnover transformation method, a left-right turnover transformation method, a rotation transformation method, a target copy and paste transformation method, and the like.

Specifically, the data enhancement module may set the same or different turn-on probability for each data enhancement method, that is, the data enhancement module randomly selects one or more of the color transformation method, the scale transformation method, the up-down turnover transformation method, the left-right turnover transformation method, the rotation transformation method, and the target copy and paste transformation method to perform data enhancement processing on the training images, so as to increase the diversity and complexity of the training image set to enrich data and help the model learn better, and improve the generalization capability and robustness of the model.

Step S150: inputting the target detection box, the target class confidence degree and the target image quality score of the plurality of candidate boxes, and the target label box, the class label, and the quality label score of the training image in the batch of images into the loss function calculation module to obtain a model loss of the multi-task network model.

Specifically, the target detection box, the target class confidence degree and the target image quality score of the plurality of candidate boxes which are obtained by inputting all the training images in the batch of images into the multi-task network model, and the target label boxes, the class labels, and the quality label scores of all the training images in the batch of images are all input into the loss function calculation module.

In the loss function calculation module, based on Formula 1, the class loss L_{cls} of the multi-task network model is calculated according to the target class confidence degree and the class label; based on Formula 2, the bounding box regression loss L_{box} of the multi-task network model is calculated according to the target detection box and the target label box; based on Formula 3, the class distribution loss L_{dfl} of the multi-task network model is calculated according to the target class confidence degree; based on the Formula 4, the image quality evaluation loss L_{iqa} of the multi-task network model is calculated according to the target image quality score, the target detection box, the target label box, and the quality label score; and based on Formula 5, the model loss Lₛᵤₘ of the multi-task network model is calculated according to the class loss L_{cls}, the bounding box regression loss L_{box}, the class distribution loss L_{dfl} and the image quality evaluation loss L_{iqa}.

Step S160: calculating a gradient of the model loss to each parameter of the multi-task network model by using a back-propagation algorithm, and updating the parameter of the multi-task network model according to the gradient.

Specifically, by starting from an output layer of the multi-task network model, the gradient of a model loss function to each parameter of the multi-task network model is calculated layer by layer by utilizing a chain rule, and then the parameter of the multi-task network model is updated by using an optimization method (such as gradient descent) and the gradient. Through repeated iteration of this process, the model loss of the multi-task network model may be gradually reduced.

Step S170: judging whether the multi-task network model converges, if so, executing step S180, and if not, returning to execute step S130.

In the example of the present application, when the model loss of the multi-task network model is no longer reduced, or when the gradient of the model loss to each parameter of the multi-task network model is very small, and the parameter of the model cannot be well updated, the multi-task network model converges, and the training of the model is stopped; otherwise, a plurality of training images are continued to be randomly extracted from the training image set to constitute a batch of images to continue to train the model until all the training images in the training image set are traversed, that is, all the training images in the training image set have been extracted to constitute a batch of images, the training is stopped, and the parameter of the multi-task network model after the parameter is updated last time is saved.

Step S180: saving a parameter of the multi-task network model.

The parameter of the model is saved for reloading and using the multi-task network model after the training is completed.

In the example of the present application, target detection, target class prediction, and image quality evaluation are performed by inputting the training images in the batch of images into the multi-task network model to obtain the target detection box, the target class confidence degree and the target image quality score of a plurality of candidate boxes of the training image, the model loss is calculated by the target detection box, the target class confidence degree and the target image quality score of the plurality of candidate boxes and the target label box, the class label and the quality label score of the training image, and the parameter of the multi-task network model is updated by the model loss, so that the trained multi-task network model performs target detection, target class prediction and image quality evaluation on the image input into the model to obtain the target detection box, the target class confidence degree and the target image quality score of the image, so as to enable the multi-task network model to predict the quality of the image including only the target foreground when the input image is an image containing the foreground and the background, thereby effectively preventing the negative impact of the background quality on the image quality prediction of the target foreground, achieving the function of target image quality evaluation on the premise of not affecting the performance of the original target detection model and not obviously increasing the memory occupancy rate of the camera side, and effectively solving the problem that the target image quality evaluation model cannot be independently added due to the resource limitation at the camera side, so as to reduce the transmission cost of target image data in the mode of target detection at the camera side and target recognition at the cloud server, reduce a bandwidth load and decrease the number of calls of the recognition model.

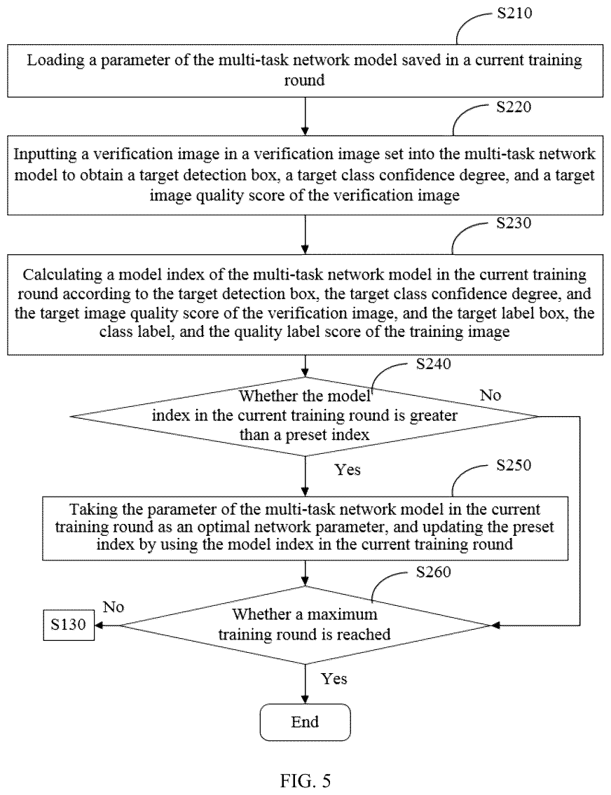

FIG. 5 shows a flowchart of a verification method for the multi-task network model provided in an example of the present application, and the verification method for the multi-task network model may be executed by an electronic device (not shown in FIG. 1) such as a local offline computer and a server for verifying the multi-task network model trained by the above examples to determine whether the multi-task network model is well trained. After the multi-task network model is trained in each training round by using the multi-task network model training method shown in the example of FIG. 2, the multi-task network model is verified by using the verification method for the multi-task network model shown in the example of FIG. 5, and therefore, the steps shown in the example of FIG. 5 are executed after step S180 in the example of FIG. 2 is executed. As shown in FIG. 5, the verification method for the multi-task network model includes the following steps.

Step S210: loading a parameter of the multi-task network model saved in a current training round.

Specifically, in the process of training the multi-task network model by using the multi-task network model training method shown in the example of FIG. 2, the parameter of the multi-task network model saved in the current training round is a parameter of the multi-task network model saved after the multi-task network model converges, or a parameter of the multi-task network model saved after the parameter is updated last time and after all the training images in the training image set is traversed.

Step S220: inputting a verification image in a verification image set into the multi-task network model to obtain a target detection box, a target class confidence degree, and a target image quality score of the verification image;
wherein the verification image set includes a plurality of verification images marked with labels, and the label includes a target label box, a class label, and a quality label score. The verification image set in this step is the verification image set constructed as described above.

Specifically, the verification image in the verification image set is input into the multi-task network model to obtain a predicted feature map of the verification image, and the predicted feature map contains a target detection box, a target class confidence degree and a target image quality score which are predicted by a plurality of candidate boxes.

Reference may be made to the above step S150 for the processing of the verification image by the multi-task network model in this step, which will not be described in detail herein.

Step S230: calculating a model index of the multi-task network model in the current training round according to the target detection box, the target class confidence degree, and the target image quality score of the verification image, and the target label box, the class label, and the quality label score of the training image.

After the predicted feature map of the verification image is obtained, non-maximum suppression processing is performed on the predicted feature map, and specifically, an optimal detection result may be selected from the detection results predicted by the plurality of candidate boxes as a target detection result, and the target detection result includes a target detection box, a target class confidence degree, and a target image quality score, for example, the detection result predicted by the candidate box where the highest target class confidence degree is located is taken as the target detection result.

Then, decoding processing is performed on the target detection box of the target detection result to obtain a target detection box, that is, the target detection box represented by the integral is converted back to the four-dimensional target detection box. Specifically, decoding processing is performed on the target detection box represented by the integral of the target detection result (usually an encoded bounding box parameter), and the above parameter may be converted back to the four-dimensional target detection box (that is, central point coordinates x, y, width w and height h).

In this example, the model index in the current training round may be a weighted sum of target detection indexes and quality evaluation indexes, wherein the target detection indexes include Precision, Recall, mAP@50 and mAP@5095, which are calculated from the target detection box and the target class confidence degree of the verification image, and the class label and the target label box of the training image; and the quality evaluation indexes include Pearson Linear Correlation Coefficient (PLCC), Spearman Rank Correlation Coefficient (SRCC) and Total (PLCC+SRCC), which are calculated from the target image quality score of the verification image and the quality label score of the training image.

Step S240: judging whether the model index in the current training round is greater than a preset index, if so, executing step S250, and if not, executing step S260.

Step S250: taking the parameter of the multi-task network model in the current training round as an optimal network parameter, and updating the preset index by using the model index in the current training round.

Step S260: judging whether a maximum training round is reached, if so, ending the flow, and if not, returning to execute step S130.

When the model index in the current training round is greater than the preset index, the parameter of the multi-task network model in the current training round is taken as the optimal network parameter, the model index in the current training round is updated to be the preset index, and after the multi-task network model is trained in the next training round in the example of FIG. 2, the parameter of the multi-task network model saved in the next training round is loaded to verify the multi-task network model trained in the next training round until the training round of the model reaches the maximum training round, so that the multi-task network model with the optimal model index in a plurality of training rounds may be taken as the finally output multi-task network model. When the model index in the current training round is less than or equal to the preset index, the optimal network parameter is not updated, and after the multi-task network model is trained in the next training round in the example of FIG. 2, the parameter of the multi-task network model saved in the next training round is loaded to verify the multi-task network model trained in the next training round until the training round of the model reaches the maximum training round.

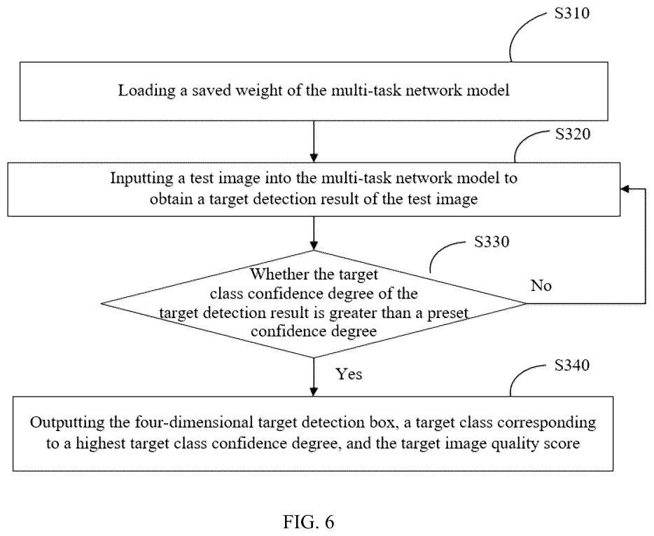

FIG. 6 shows a flowchart of a test method for the multi-task network model provided in an example of the present application, and the method may be executed by an electronic device (not shown in FIG. 1) such as a local offline computer and a server for testing the multi-task network model trained by the above examples to determine whether the multi-task network model is well trained. The steps shown in the example of FIG. 6 are executed after step S180 in the example of FIG. 2 is executed, or are executed after step S260 in the example of FIG. 5 is executed. As shown in FIG. 6, the test method for the multi-task network model includes the following steps.

Step S310: loading a saved parameter of the multi-task network model.

The parameter loaded in this step may be the parameter of the multi-task network model trained in the example shown in FIG. 2, and may also be the parameter of the multi-task network model verified in the example shown in FIG. 5.

Step S320: inputting a test image into the multi-task network model to obtain a target detection result of the test image.

In the example of the present application, the test image may be a video image shot by any camera apparatus for a test model, including but not limited to a person video, an animal video, an automobile video, and the like;
wherein the target detection result of the test image includes a target detection box, a target class confidence degree, and a target image quality score.

Specifically, the test image is input into the multi-task network model to obtain a predicted feature map including a target detection box, a target class confidence degree and a target image quality score which are predicted by a plurality of candidate boxes. The non-maximum suppression processing is performed on the predicted feature map, and the target detection result in the plurality of candidate boxes is screened out, wherein the target detection result includes the target detection box, the target class confidence degree, and the target image quality score. The decoding processing is performed on the target detection box of the target detection result to obtain the target detection box, and the target class corresponding to the highest target class confidence degree is taken as the target class of the target detection box.

When the target detection box contains only targets of one class, the target detection box corresponds to only one target class confidence degree, and the target detection box contains targets of a plurality of classes, for example, targets such as animals, persons and automobiles, the target detection box corresponds to three target class confidence degrees.

In this case, it is necessary to select the target class corresponding to the highest target class confidence degree from one or more target class confidence degrees as the target class of the target detection box. For example, assuming that the target class confidence degree 1 of one target detection box is 80%, the target class confidence degree 2 is 90%, the target class corresponding to the target class confidence degree 1 is a person, and the target class corresponding to the target class confidence degree 2 is an animal, the target class of the target detection box is the animal.

Reference may be made to the above step S150 for the processing of the test image by the multi-task network model in this step, which will not be described in detail herein.

Step S330: judging whether the target class confidence degree of the target detection result is greater than a preset confidence degree, if so, executing step S340, and if not, returning to execute step S320.

In this step, magnitudes of the highest target class confidence degree and the preset confidence degree may be directly compared. When the highest target class confidence degree is greater than the preset confidence degree (for example, 0.45), it indicates that the multi-task network model considers that predicting the target in the target detection box of the test image to be of a certain type is relatively reliable, and then the target detection box, the target class and the target image quality score of the test image are output; and when the highest target class confidence degree is less than or equal to the preset confidence degree (for example, 0.45), it indicates that the multi-task network model considers that predicting the target in the target detection box of the test image to be of a certain type is unreliable, any content of the test image is not output, and test images are extracted from the video collected by the camera apparatus again frame by frame to test the multi-task network model.

Step S340: outputting the target detection box, the target class corresponding to the highest target class confidence degree, and the target image quality score.

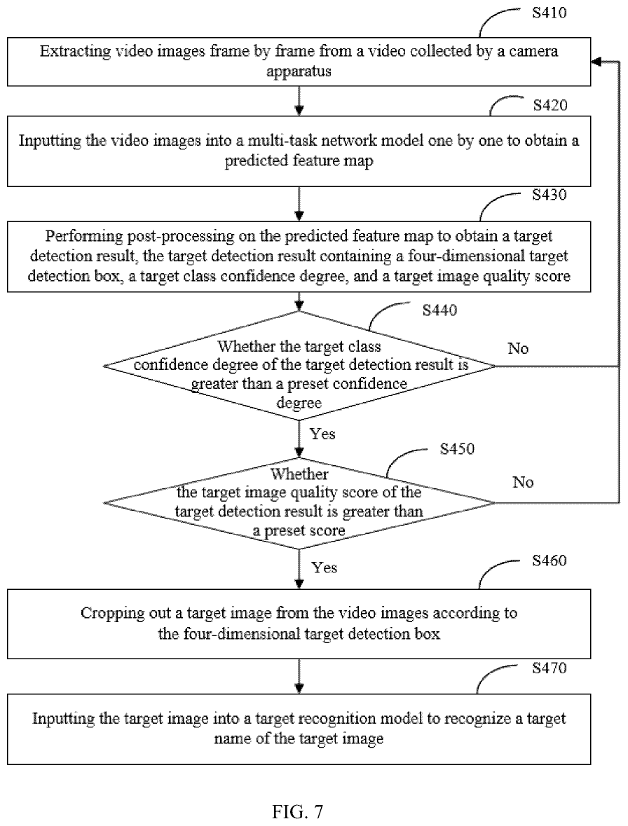

FIG. 7 shows a flowchart of a target recognition method provided in an example of the present application, and the method may be used for intelligent video monitoring. In this example, the method is executed by the above camera apparatus 1, wherein a trained multi-task network model and a target recognition model are installed and operated on the camera apparatus 1, and the camera apparatus 1 directly extracts video images from the shot video frame by frame to perform target detection and target recognition to obtain a target detection result (such as a target image) and a target recognition result (such as a target name). In another example, the method may also be executed jointly by the camera apparatus 1 and the cloud server 2, wherein the trained multi-task network model is installed and operated on the camera apparatus 1, and the target recognition model which may recognize a plurality of target types is installed and operated on the cloud server 2. The camera apparatus 1 extracts video images from the shot video frame by frame, performs target detection through the trained multi-task network model to obtain a target image, and then sends the target image to the cloud server 2 via a network 3, and the cloud server 2 calls the target recognition model to perform target recognition on the target image to obtain a target recognition result (for example, the target name). The multi-task network model used in the example of the present application is trained by the multi-task network model training method for target recognition in the above examples, and uses the verification method and the test method for the multi-task network model in the above examples for verification and testing. Reference may be made to the above description for the steps in this example which are the same as or similar to those in the examples shown in FIG. 2, FIG. 5 and FIG. 6, and the detailed implementation processes and advantageous effects thereof will not be described in detail in this example. With reference to FIG. 7, the target recognition method includes the following steps.

Step S410: extracting video images frame by frame from a video collected by a camera apparatus.

In this example, the video may be a video shot by the camera apparatus 1, including but not limited to a person video, an animal video, an automobile video, and the like.

Optionally, the video image may include one, two or more targets, for example, the targets included in the video image may be: an animal A, an animal A and an animal B, a person A, a person A and a person B, the animal A and the person A, the person A and an automobile A, the animal A, the person A and the automobile A, and the like.

Step S420: inputting the video images into a multi-task network model one by one to obtain a predicted feature map;
wherein the multi-task network model includes a feature extraction module, a multi-scale feature fusion module and a detection head module, the detection head module includes a plurality of scale branches, each scale branch includes a detection regression branch, a class prediction branch and a quality evaluation branch, a last convolution layer of the quality evaluation branch is connected in parallel with a last convolution layer of the detection regression branch, and the quality evaluation branch and the detection regression branch share remaining convolution layers;
wherein the predicted feature map includes a detection result of a plurality of candidate boxes, each candidate box corresponds to one detection result, each detection result includes a target detection box, a target class confidence degree and a target image quality score, the target detection box is output by the detection regression branch, the target class confidence degree is output by the class prediction branch, and the target image quality score is output by the quality evaluation branch.

Step S420 specifically includes:
step c1: inputting the video images into a feature extraction module one by one, and performing feature extraction on the video images through the feature extraction module to obtain feature maps of the video images at different scales;
step c2: inputting the feature maps at different scales into the multi-scale feature fusion module, and performing feature fusion on the feature maps at different scales through the multi-scale feature fusion module to obtain fused feature maps of the video images at different scales; and
step c3: inputting the fused feature maps at different scales into the detection head module, performing target detection prediction on the fused feature maps through the detection regression branch to obtain the target detection box of the plurality of candidate boxes, performing target class prediction on the fused feature maps through the class prediction branch to obtain the target class confidence degrees of the plurality of candidate boxes, and performing quality evaluation prediction on the fused feature maps through the quality evaluation branch to obtain the target image quality score of the plurality of candidate boxes.

Taking the multi-task network model trained by using the animal image and the person image as an example, when the video image includes one animal A, the predicted feature map includes a plurality of target detection boxes taking the animal A as a target, a plurality of target class confidence degrees taking the animal A as the target, and a plurality of target image quality scores taking the animal A as a foreground image which are predicted by a plurality of candidate boxes; and when the video image includes one animal A and one animal B, the predicted feature map includes a plurality of target detection boxes taking the animal A and the animal B as targets, a plurality of target class confidence degrees 1 taking the animal A as the target and a plurality of target class confidence degrees 2 taking the animal B as the target, and a plurality of target image quality scores taking the animal A and the animal B as foreground images which are predicted by a plurality of candidate boxes.

Step S430: performing post-processing on the predicted feature map to obtain a target detection result, the target detection result containing a target detection box, a target class confidence degree, and a target image quality score.

Step S430 specifically includes:
step d1: performing non-maximum suppression processing on the predicted feature map to screen out the target detection result from a plurality of candidate boxes; and
step d2: performing decoding processing on a target detection box of the target detection result to obtain the target detection box.

In this step, the detection result where the highest target class confidence degree is located may be screened out from the plurality of candidate boxes as the target detection result.

When the video image includes only one target, such as the animal A, the target detection result screened in step S430 includes: the target detection box taking the animal A as the target, the target class confidence degree taking the animal A as the target, and target image quality score taking the animal A as the foreground image; and when the video image includes two targets, for example, the animal A and the animal B, the target detection result screened in step S430 includes: the target detection box taking the animal A and the animal B as targets, the target class confidence degree 1 taking the animal A as the target and the target class confidence degree 2 taking the animal B as the target, and the target image quality score taking the animal A and the animal B as foreground images.

Specifically, the target detection box is obtained after performing decoding processing on the target detection box represented by the integral in the target detection result.

Step S440: judging whether the target class confidence degree of the target detection result is greater than a preset confidence degree, if so, executing step S450, and if not, returning to execute step S410.

In this example, when the target class confidence degree of the target detection result is greater than the preset confidence degree (for example, 0.45), it indicates that the multi-task network model considers that predicting the target in the target detection box of the video image to be of a certain type is relatively reliable, and then the target detection box and the target image quality score are displayed; and when the target class confidence degree of the target detection result is less than or equal to a preset confidence degree threshold value (for example, 0.45), it indicates that the multi-task network model considers that predicting the target in the target detection box of the video image to be of a certain type is unreliable, the target detection box and the target image quality score are not displayed, and the video images are continued to be acquired to perform target detection and target image quality evaluation.

Step S450: judging whether the target image quality score of the target detection result is greater than a preset score, if so, executing step S460, and if not, returning to execute step S410. Assuming that the target image quality score is measured by adopting a centesimal system, the preset score may be set to be any score value within an interval of 80 points to 100 points, for example, 80 points or 90 points, and is specifically set according to the image quality satisfaction required by a user.

When the target image quality score is greater than the preset score, it indicates that the target image quality in the target detection box satisfies the requirements; and when the target image quality score is less than or equal to a preset evaluation threshold value, it indicates that the target image quality in the target detection box does not satisfy the requirements.

Step S460: cropping out a target image from the video images according to the target detection box.

Specifically, when the target image quality in the target detection box satisfies the requirements, the video images are cropped according to the target detection box to obtain a target image containing only a target foreground.

Step S470: inputting the target image into a target recognition model to recognize a target name of the target image.

In the example of the present application, the target image and the target name may be simultaneously output to a terminal device 4, or directly displayed on a display screen of the terminal device 4.

In the example of the present application, a pre-trained target recognition model may be used to recognize the target image, and a target recognition model which has been self-trained according to specific requirements may also be used. The target recognition model may be operated in the camera apparatus 1 or the cloud server 2.

For example, when the target image contains a target of a class of the animal A, the target image is input into the target recognition model to perform target recognition to obtain the target name: the animal A. When the target image contains targets of a plurality of classes, the target name of the target image recognized by the target recognition model is the target name corresponding to the highest target class confidence degree in the target detection result, for example, when the target image includes targets of three classes, namely, the animal A, the person A and the automobile A, and the target name corresponding to the highest target class confidence degree in the target detection result is the animal A, the target image is input into the target recognition model to perform target recognition to obtain the target name: the animal A.

In some examples, the target class corresponding to the highest target class confidence degree may be taken as the target class of the target detection box in step S430.

When the target detection box in the target detection result contains only the target of one class, the target detection box corresponds to only one target class confidence degree, and then the target class corresponding to the target class confidence degree is taken as the target class of the target detection box.

When the target detection box in the target detection result contains targets of a plurality of classes, for example, targets such as animals, persons and automobiles, the target detection box corresponds to three target class confidence degrees, and then the target class corresponding to the highest target class confidence degree in the three target class confidence degrees is taken as the target class of the target detection box. For example, when the target class confidence degree of the person of the target detection box is 80%, the target class confidence degree of the animal is 95%, and the target class confidence degree of the automobile is 90%, the target class of the target detection box is the animal.

Accordingly, when it is judged in step S440 that the target class confidence degree of the target detection result is greater than the preset confidence degree, the target class, the target detection box and the target image quality score may be displayed simultaneously.

In this case, in this step S470, the cropped target image may be input into the target recognition model corresponding to the target class to perform target recognition. Specifically, assuming that the target image contains targets of three classes, namely, the animal A, the person A and the automobile A, when the displayed target class is the animal, the target image is input into an animal recognition model to perform target recognition to obtain a target recognition result output by the animal recognition model: the animal A; when the displayed target class is the person, the target image is input into a person recognition model to perform target recognition to obtain a target recognition result output by the person recognition model: the person A; and when the target class displayed in this step is the automobile, the target image is input into an automobile recognition model to perform target recognition to obtain a target recognition result output by the automobile recognition model: the automobile A.

Reference may be made to the examples shown in FIG. 2, FIG. 5 and FIG. 6 for the specific implementation processes and principles of the above steps, which will not be described in detail herein.

In the example of the present application, by inputting the video images extracted frame by frame into the multi-task network model to perform target detection, target class prediction and image quality evaluation, the predicted feature map including the target detection box, the target class confidence degree and the target image quality score of a plurality of candidate boxes is obtained; the target detection result is obtained by performing post-processing on the predicted feature map, and when the target class confidence degree of the target detection result is greater than the preset confidence degree and the target image quality score of the target detection result is greater than the preset score, the target image which is obtained by cropping the video images according to the target detection box of the target detection result and only contains the target foreground is input into the target recognition model to perform target recognition to obtain the target name; by using the multi-task network model to predict and obtain the image which only contains the target foreground and predict the quality of the image, the quality of the target image input into the target recognition model may be controlled, which not only effectively reduces the target misrecognition rate, but also decreases the number of calls of the target recognition model and reduces the operation load of a camera device. In addition, in the mode of target detection at the camera side and target recognition at the cloud server, the transmission cost of target image data may be reduced, the storage of useless information may be avoided, and the bandwidth load and the memory occupancy rate may be reduced.

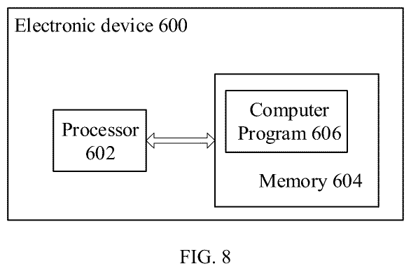

FIG. 8 shows a schematic structural diagram of an electronic device provided in an example of the present application, the electronic device may be the camera apparatus 1, the cloud server 2, the terminal device 4 and the offline computer device which are described above, and the specific implementation of the electronic device is not limited in the specific examples of the present disclosure.

As shown in FIG. 8, the electronic device 600 may include: a processor 602 and a memory 604;
wherein the memory 604 is used to store a computer program 606. The memory 604 may contain a high-speed RAM, and may also include a non-volatile memory, such as at least one disk memory. The computer program 606 may include computer-executable instructions.

The processor 602 is used to execute the computer program 606 to implement the steps in the above examples of the target recognition method.

The processor 602 may be a central processing unit (CPU), or an application specific integrated circuit (ASIC), or one or more integrated circuits configured to implement the examples of the present disclosure. The electronic device includes one or more processors, which may be processors of the same type, such as one or more CPUs, and may also be processors of different types, such as one or more CPUs and one or more ASICs.

An example of the present application provides a computer-readable storage medium having a computer program stored thereon, wherein the computer program, when executed by one or more processors, implements the above examples of the target recognition method, or implements the above examples of the multi-task network model training method.

An example of the present application provides a computer program executable by one or more processors to implement the above examples of the target recognition method, or implement the above examples of the multi-task network model training method.

An example of the present application provides a computer program product, including a computer program which, when executed by one or more processors, implements the above examples of the target recognition method, or implements the above examples of the multi-task network model training method.

In a few examples provided in the present application, if any of the functions is implemented in the form of a software functional module/unit and sold or used as a stand-alone product, it may be stored in one computer-readable storage medium. Based on such an understanding, some or all of the technical solutions of the present application may be embodied in the form of software products, and the computer software product is stored in one storage medium and includes a plurality of instructions for causing one computer device (which may be an electronic device such as a personal computer and a server) to execute all or some of the steps of the methods described in various examples of the present application, while the above storage medium includes: various media which may store computer program codes such as a USB flash disk, a mobile hard disk, a Read-Only Memory (ROM), a Random Access Memory (RAM), a magnetic disk or an optical disk.

The examples described above express only a few embodiments of the present application and are described in more detail, but should not therefore be construed as limiting the patent scope of the present application. It should be noted that a person ordinarily skilled in the art would be able to make several variations and modifications without departing from the concept of the present application, and these are all within the scope of protection of the present application. Therefore, the scope of protection of the present application should be defined by the appended claims.

What is claimed is:

1. A target recognition method, comprising:
inputting a plurality of video images into a multi-task network model one by one to obtain a predicted feature map;
performing post-processing on the predicted feature map to obtain a target detection result, the target detection result comprising a target detection box, a target class confidence degree, and a target image quality score;
judging whether the target class confidence degree is greater than a preset confidence degree;
judging whether the target image quality score is greater than a preset score if the target class confidence degree is greater than the preset confidence degree;
cropping out a target image from the video images according to the target detection box if the target image quality score is greater than the preset score; and
inputting the target image into a target recognition model to recognize a target name of the target image.

2. The target recognition method according to claim 1, wherein the performing post-processing on the predicted feature map to obtain a target detection result, comprises:
performing non-maximum suppression processing on the predicted feature map to screen out the target detection result from a plurality of candidate boxes; and
performing decoding processing on a target detection box of the target detection result to obtain the target detection box.

3. The target recognition method according to claim 1, wherein the multi-task network model comprises a feature extraction module, a multi-scale feature fusion module, and a detection head module, the detection head module comprises a plurality of scale branches, each scale branch comprises a detection regression branch, a class prediction branch, and a quality evaluation branch, a last convolution layer of the quality evaluation branch is connected in parallel with a last convolution layer of the detection regression branch, the quality evaluation branch and the detection regression branch share remaining convolution layers, the predicted feature map contains the target detection box, the target class confidence degree and the target image quality score of the plurality of candidate boxes, the target detection box is output by the detection regression branch, the target class confidence degree is output by the class prediction branch, and the target image quality score is output by the quality evaluation branch.

4. The target recognition method according to claim 3, wherein the inputting the video images into a multi-task network model one by one to obtain a predicted feature map, comprises:
inputting the video images into a feature extraction module one by one, and performing feature extraction on the video images through the feature extraction module to obtain feature maps of the video images at different scales;
inputting the feature maps at different scales into the multi-scale feature fusion module, and performing feature fusion on the feature maps at different scales through the multi-scale feature fusion module to obtain fused feature maps of the video images at different scales;
inputting the fused feature maps at different scales into the detection head module;
performing target detection prediction on the fused feature maps through the detection regression branch to obtain the target detection box of the plurality of candidate boxes;
performing target class prediction on the fused feature maps through the class prediction branch to obtain the target class confidence degrees of the plurality of candidate boxes; and
performing quality evaluation prediction on the fused feature maps through the quality evaluation branch to obtain the target image quality score of the plurality of candidate boxes.

5. A multi-task network model training method for target recognition, comprising:
constructing the multi-task network model;
constructing a loss function calculation module;
randomly extracting a plurality of training images in a training image set to constitute a batch of images, wherein the training image set comprises a plurality of training images marked with labels, and the label comprises a target label box, a class label, and a quality label score;
inputting the training images in the batch of images into the multi-task network model one by one to obtain a predicted feature map, wherein the predicted feature map comprises a target detection box, a target class confidence degree and a target image quality score of a plurality of candidate boxes;
inputting the target detection box, the target class confidence degree and the target image quality score of the plurality of candidate boxes, and the target label box, the class label, and the quality label score of the training image in the batch of images into the loss function calculation module to obtain a model loss of the multi-task network model;
calculating a gradient of the model loss to each parameter of the multi-task network model by using a back-propagation algorithm, and updating parameters of the multi-task network model according to the gradient;
judging whether the multi-task network model converges;
saving the parameters of the multi-task network model if the multi-task network model converges;
executing the step of randomly extracting a plurality of training images in a training image set to constitute a batch of images if the multi-task network model does not converge.

6. The multi-task network model training method according to claim 5, wherein a total number of images of the batch of images is N, wherein N≥1; the model loss Lₛᵤₘ of the multi-task network model is as follows:
$${L}_{sum} = {λ}_{cls} {L}_{cls} + {λ}_{box} {L}_{box} + {λ}_{dfl} {L}_{dfl} + {λ}_{iqa} {L}_{iqa}$$
where L_{cls} represents a class loss of the multi-task network model, L_{box} represents a bounding box regression loss of the multi-task network model, L_{dfl} represents a class distribution loss of the multi-task network model, L_{iqa} represents an image quality evaluation loss of the multi-task network model, and λ_{cls}, λ_{box}, λ_{dfl} and λ_{iqa} represent parameters of L_{cls}, L_{box}, L_{dfl} and L_{iqa} respectively;
the image quality evaluation loss L_{iqa} of the multi-task network model is as follows:
$${L}_{iqa} = \frac{1}{N} {\sum }_{i = 1}^{N} ( \vert {IQA}_{g t} - {IQA}_{pred} \vert \times IoU \times flag )$$
where IQA_{gt} represents the quality label score of the training image, IQA_{pred} represents the target image quality score of the training image, IoU represents a ratio of an intersection set area and a union set area of the target label box and the target detection box of the training image, flag represents whether a flag bit of the quality label score exists in the training image, if the quality label score exists in the training image, flag is 1, and if the quality label score does not exist in the training image, flag is 0.

7. The multi-task network model training method according to claim 5, further comprising:
constructing a data enhancement module, wherein the data enhancement module uses at least one of a plurality of data enhancement methods to perform data enhancement on an image, and the plurality of data enhancement methods comprise a color transformation method, a scale transformation method, an up-down turnover transformation method, a left-right turnover transformation method, a rotation transformation method, and a target copy and paste transformation method.

8. The multi-task network model training method according to claim 7, wherein the inputting the training images in the batch of images into the multi-task network model one by one to obtain a predicted feature map, comprises:
inputting the training images in the batch of images into the data enhancement module one by one to obtain a data enhancement image; and
inputting the data enhancement image into the multi-task network model to obtain the predicted feature map.

9. The multi-task network model training method according to claim 5, further comprising: verifying the multi-task network model, a verification method for the multi-task network model comprising the following steps:
loading a parameter of the multi-task network model saved in a current training round;
inputting a verification image in a verification image set into the multi-task network model to obtain a target detection box, a target class confidence degree, and a target image quality score of the verification image, wherein the verification image set comprises a plurality of verification images marked with labels, and the label comprises a target label box, a class label, and a quality label score;
calculating a model index of the multi-task network model in the current training round according to the target detection box, the target class confidence degree, and the target image quality score of the verification image, and the target label box, the class label, and the quality label score of the training image;
judging whether the model index in the current training round is greater than a preset index;
if the model index in the current training round is greater than the preset index, taking the parameter of the multi-task network model in the current training round as an optimal network parameter, updating the preset index by using the model index in the current training round, and executing the step of randomly extracting a plurality of training images in a training image set to constitute a batch of images until a maximum training round is reached;
if the model index in the current training round is less than or equal to the preset index, executing the step of randomly extracting a plurality of training images in a training image set to constitute a batch of images until the maximum training round is reached.

10. The multi-task network model training method according to claim 5, further comprising: testing the multi-task network model, a test method for the multi-task network model comprising the following steps:
loading a saved parameter of the multi-task network model;
inputting a test image into the multi-task network model to obtain a target detection result of the test image, wherein the target detection result comprises a target detection box, a target class confidence degree, and a target image quality score;
judging whether the target class confidence degree of the target detection result is greater than a preset confidence degree;
if the target class confidence degree of the target detection result is greater than the preset confidence degree, outputting the target detection box, a target class corresponding to a highest target class confidence degree, and the target image quality score; and
if the target class confidence degree of the target detection result is less than or equal to the preset confidence degree, executing the step of inputting a test image into the multi-task network model to obtain a target detection result of the test image.

11. The multi-task network model training method according to claim 5, further comprising:
generating one image quality label interface and displaying the image quality label interface on a display screen of an electronic device;
displaying the training image and a target rectangular box on the image quality label interface;
when the target rectangular box is selected, performing mask processing on all backgrounds outside a selected target foreground of the training image, an image in the target rectangular box being a target image;
performing quality scoring on the target image to obtain the quality label score.

12. The multi-task network model training method according to claim 5, wherein the multi-task network model comprises a feature extraction module, a multi-scale feature fusion module, and a detection head module, the detection head module comprises a plurality of scale branches, each scale branch comprises a detection regression branch, a class prediction branch, and a quality evaluation branch, a last convolution layer of the quality evaluation branch is connected in parallel with a last convolution layer of the detection regression branch, and the quality evaluation branch and the detection regression branch share remaining convolution layers.

13. The multi-task network model training method according to claim 12, wherein the detection regression branch outputs the target detection box, the class prediction branch outputs the target class confidence degree, and the quality evaluation branch outputs the target image quality score.

14. An electronic device, comprising a memory, a processor, and a computer program stored on the memory, wherein the processor executes the computer program to:
input a plurality of video images into a multi-task network model one by one to obtain a predicted feature map;
perform post-processing on the predicted feature map to obtain a target detection result, the target detection result comprising a target detection box, a target class confidence degree, and a target image quality score;
determine whether the target class confidence degree is greater than a preset confidence degree;
determine whether the target image quality score is greater than a preset score if the target class confidence degree is greater than the preset confidence degree;
crop out a target image from the video images according to the target detection box if the target image quality score is greater than the preset score; and
input the target image into a target recognition model to recognize a target name of the target image.

15. The electronic device according to claim 14, wherein the post-processing is performed on the predicted feature map to obtain the target detection result by executing the following steps:
performing non-maximum suppression processing on the predicted feature map to screen out the target detection result from a plurality of candidate boxes; and
performing decoding processing on a target detection box of the target detection result to obtain the target detection box.

16. The electronic device according to claim 14, wherein the multi-task network model comprises a feature extraction module, a multi-scale feature fusion module, and a detection head module, the detection head module comprises a plurality of scale branches, each scale branch comprises a detection regression branch, a class prediction branch, and a quality evaluation branch, a last convolution layer of the quality evaluation branch is connected in parallel with a last convolution layer of the detection regression branch, the quality evaluation branch and the detection regression branch share remaining convolution layers, the predicted feature map contains the target detection box, the target class confidence degree and the target image quality score of the plurality of candidate boxes, the target detection box is output by the detection regression branch, the target class confidence degree is output by the class prediction branch, and the target image quality score is output by the quality evaluation branch.

17. The electronic device according to claim 16, wherein the predicted feature map is obtained by executing the following steps:
inputting the video images into the feature extraction module one by one, and performing feature extraction on the video images through the feature extraction module to obtain feature maps of the video images at different scales;
inputting the feature maps at different scales into the multi-scale feature fusion module, and performing feature fusion on the feature maps at different scales through the multi-scale feature fusion module to obtain fused feature maps of the video images at different scales;
inputting the fused feature maps at different scales into the detection head module;
performing target detection prediction on the fused feature maps through the detection regression branch to obtain the target detection box of the plurality of candidate boxes;
performing target class prediction on the fused feature maps through the class prediction branch to obtain the target class confidence degrees of the plurality of candidate boxes; and
performing quality evaluation prediction on the fused feature maps through the quality evaluation branch to obtain the target image quality score of the plurality of candidate boxes.

18. The electronic device according to claim 14, wherein the multi-task network model is trained by performing a training method comprising:
constructing the multi-task network model;
constructing a loss function calculation module;
randomly extracting a plurality of training images in a training image set to constitute a batch of images, wherein the training image set comprises a plurality of training images marked with labels, and the label comprises a target label box, a class label, and a quality label score;
inputting the training images in the batch of images into the multi-task network model one by one to obtain the predicted feature map;
inputting the target detection box, the target class confidence degree and the target image quality score of the plurality of candidate boxes, and the target label box, the class label, and the quality label score of the training image in the batch of images into the loss function calculation module to obtain a model loss of the multi-task network model;
calculating a gradient of the model loss to each parameter of the multi-task network model by using a back-propagation algorithm, and updating the parameter of the multi-task network model according to the gradient;
judging whether the multi-task network model converges;
saving a parameter of the multi-task network model if the multi-task network model converges;
executing the step of randomly extracting a plurality of training images in a training image set to constitute a batch of images if the multi-task network model does not converge.

19. The electronic device according to claim 18, wherein the training method further comprises:
verifying the multi-task network model, a verification method for the multi-task network model comprising the following steps:
loading a parameter of the multi-task network model saved in a current training round;
inputting a verification image in a verification image set into the multi-task network model to obtain a target detection box, a target class confidence degree, and a target image quality score of the verification image, wherein the verification image set comprises a plurality of verification images marked with labels, and the label comprises a target label box, a class label, and a quality label score;
calculating a model index of the multi-task network model in the current training round according to the target detection box, the target class confidence degree, and the target image quality score of the verification image, and the target label box, the class label, and the quality label score of the training image;
judging whether the model index in the current training round is greater than a preset index;
if the model index in the current training round is greater than the preset index, taking the parameter of the multi-task network model in the current training round as an optimal network parameter, updating the preset index by using the model index in the current training round, and executing the step of randomly extracting a plurality of training images in a training image set to constitute a batch of images until a maximum training round is reached;
if the model index in the current training round is less than or equal to the preset index, executing the step of randomly extracting a plurality of training images in a training image set to constitute a batch of images until the maximum training round is reached.

20. The electronic device according to claim 18, wherein the training method further comprises:
generating one image quality label interface and displaying the image quality label interface on a display screen of the electronic device;
displaying the training image and a target rectangular box on the image quality label interface;
when the target rectangular box is selected, performing mask processing on all backgrounds outside a selected target foreground of the training image, an image in the target rectangular box being a target image;
performing quality scoring on the target image to obtain the quality label score.
